(19) United States
(12) Patent Application Publication
(10) Pub. No.: US 2025/0081871 A1
(43) Pub. Date: Mar. 13, 2025

(54) PERFORATOR FOR LAWN AERATOR AND LAWN AERATOR HAVING SAME

(71) Applicant: Suzhou Firefly Information Technology Co., Ltd., Suzhou (CN)

(72) Inventor: Muzhi HUANG, Suzhou (CN)

(73) Assignee: Suzhou Firefly Information Technology Co., Ltd., Suzhou (CN)

(21) Appl. No.: 18/604,299

(22) Filed: Mar. 13, 2024

(30) Foreign Application Priority Data
Sep. 8, 2023 (CN) 202322448128.1

(51) Int. Cl. A01B 45/02

(52) U.S. Cl. CPC A01B 45/02

(57) ABSTRACT

Disclosed are a perforator and a lawn aerator. The perforator includes a main portion and a plurality of perforating portions. The main portion is in a disk shape, and the plurality of perforating portions are integrally formed with the main portion. The plurality of perforating portions extend radially outward from an outer periphery of the main portion, and arranged at intervals in a circumferential direction. Each perforating portion is recessed in an axial direction, so that two opposite surfaces of the perforating portion in the axial direction are respectively a first concave surface and a first convex surface. According to this configuration, both a relatively high density of the aeration holes and a relatively large aeration hole size can be obtained. In addition, the first concave surface and the first convex surface can help to strengthen the perforating portion, thereby preventing the perforating portion from deforming.

### CROSS-REFERENCE TO RELATED APPLICATIONS

This application claims priority to Chinese Patent Application No. 202322448128.1, filed on Sep. 8, 2023, which is hereby incorporated by reference in its entirety.

### TECHNICAL FIELD

The present disclosure relates to a field of grassland care, in particular to a perforator for a lawn aerator and a lawn aerator having the perforator.

### BACKGROUND

After years of cultivation, soil is prone to harden, plants are susceptible to diseases and weak in growth. To solve this problem, lawn aerators are usually used to break hardened soil and aerate the soil. However, when a traditional lawn aerator is used to perforate soil, a perforating portion of the lawn aerator is prone to deformation usually because of hard soil matrix, which affects the perforating performance. In addition, to ensure a certain density of aeration holes, a size of each aeration hole is sacrificed, which affects final soil aerating performance.

### SUMMARY

The present disclosure provides a perforator for a lawn aerator and a lawn aerator having the perforator, so as to achieve both a relatively high density of aeration holes and a relatively large aeration hole size.

In a first aspect, the present disclosure provides a perforator for a lawn aerator. The perforator includes a main portion and a plurality of perforating portions. The main portion is in a disk shape. The plurality of perforating portions are integrally formed with the main portion. The plurality of perforating portions extend radially outward from an outer periphery of the main portion, and arranged at intervals in a circumferential direction of the main portion. Each perforating portion is recessed in an axial direction of the perforator, so that two opposite surfaces of the perforating portion in the axial direction are respectively a first concave surface and a first convex surface.

In practice, the inventor found that the size of a single aeration hole is greatly influenced by the number of perforating portions of the perforator because of the flat structure of the perforating portions of the traditional perforator, that is, the more the perforating portions arranged in the circumferential direction, the smaller the size of the single aeration hole, which ultimately leads to the failure to achieve both a relatively high density of the aeration holes and a relatively large aeration hole size. Meanwhile, with the flat structure of the perforating portions of the traditional perforator, under a force in the axial direction of the perforator, the perforating portions are prone to deform.

According to the perforating portions provided by the present disclosure, each perforating portion is recessed in the axial direction of the perforator, as well as the first concave surface and the first convex surface are formed on two opposite side surfaces of the perforating portion in the axial direction, which enlarge the outline of a single aeration hole in the soil without reducing the number of the perforating portions arranged in the circumferential direction. Therefore, both a relatively high density of the aeration holes and a relatively high aeration hole size are obtained. In addition, in order to improve the strength of the perforating portion in the axial direction of the perforator, in the present disclosure, the first concave surface and the first convex surface are formed on the two opposite side surfaces of the perforating portion in the axial direction, which will help to strengthen the perforating portion, thereby preventing the perforating portion from deforming under the force in the axial direction during the perforator rotating.

In an embodiment, the main portion is provided with a plurality of reinforcement portions respectively connected to the plurality of perforating portions. Each reinforcement portion extends radially from a corresponding perforating portion, and the reinforcement portion is recessed in the axial direction, so that two opposite side surfaces of the reinforcement portion in the axial direction are respectively a second concave surface and a second convex surface. The first concave surface and the second concave surface are on the same side of the perforator in the axial direction, and the first convex surface and the second convex surface are on the same side of the perforator in the axial direction. That is, the second concave surface is an extension of the first concave surface in the radial direction, and the second convex surface is an extension of the first convex surface in the radial direction. Therefore, there is a depression at the intersection of the perforating portion and the main portion, which increases the radian of the intersection.

In the present disclosure, the second concave surface and the second convex surface respectively formed on the two opposite side surfaces of the reinforcement portion in the axial direction can improve the bending strength of the main portion.

In order to avoid “tearing” caused by excessive shear stress at the intersection of the main portion and the perforating portion, in the present disclosure, the second concave surface and the second convex surface, respectively formed on the two opposite side surfaces of the reinforcement portion in the axial direction, extend to the first concave surface and the first convex surface through the intersection of the main portion and the perforating portion, so that the shear stress generated at the intersection can be better absorbed to obtain a greater bending strength.

It can be understood that when the surface roughness is constant, the larger the contact area, the greater the friction. Because one side of the perforator has the first concave surface and the second concave surface, when the perforator is partially inserted into the ground, the friction, on the side of the perforator, affecting advancing of the side along the moving direction and coming from the ground, is reduced. In order to reduce the friction, on the other side of the perforator, affecting the advancing of the other side along the moving direction and coming from the ground, the first convex surface and the second convex surface are provided. Meanwhile, the friction is also reduced when the perforator goes into and out of the soil, thus improving the speed of perforating the soil. Therefore, perforating the soil is more labor-saving.

In an embodiment, an arc transition portion is arranged between any two adjacent perforating portions. Along the circumferential direction, the arc transition portion can avoid stress concentration and further improve the connection strength between the main portion and the perforating portion.

In an embodiment, each perforating portion gradually narrows towards a side away from the main portion in a radial direction of the main portion. This helps to increase the pressure, facilitate inserting into the soil and breaking the soil caking.

In an embodiment, the main portion defines a central hole, and the perforator is provided with a flange at the edge of the central hole. The flange can help to increase the contact area with the sleeve passing through it, and make the connection between the sleeve and the perforator more stable.

In a second aspect, the present disclosure provides a lawn aerator including the perforator according to the first aspect.

### BRIEF DESCRIPTION OF THE DRAWINGS

In order to explain the technical scheme of the embodiments of the present disclosure more clearly, the drawings needed in the embodiments will be briefly introduced below.

It should be understood that the following drawings illustrate only certain embodiments of the present disclosure and therefore should not be considered as limiting the scope.

It should be understood that the same or similar reference numerals are used in the drawings to indicate the same or similar elements (structures or components).

It should be understood that the drawings are only schematic, and the dimensions and proportions of elements (structures or components) in the drawings are not necessarily accurate.

FIG. 1 is a schematic structural view of a perforator for a lawn aerator according to the prior art.

FIG. 2 is a schematic structural view of a perforator for a lawn aerator according to an embodiment of the present disclosure.

FIG. 3 is a schematic structural view illustrating the perforator shown in FIG. 2 taken from another view angle.

### DETAILED DESCRIPTION OF THE EMBODIMENTS

The following will provide relative clear descriptions of the technical solutions in the embodiments of the present disclosure, in conjunction with the accompanying drawings. It should be understood that the described embodiments are only a part of the embodiments of the present disclosure, not all of them.

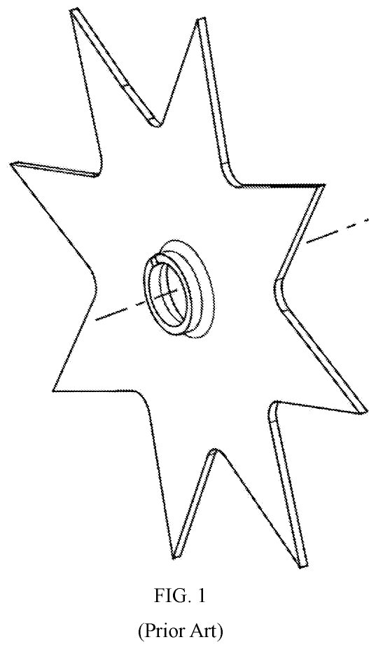

As shown in FIG. 1, a perforator for a lawn aerator according to the prior art is flat. Therefore, aeration holes created by the perforator is small. In addition, with the flat structure, the stress that the perforator can withstand and is caused by the force in an axial direction of the perforator is relative less.

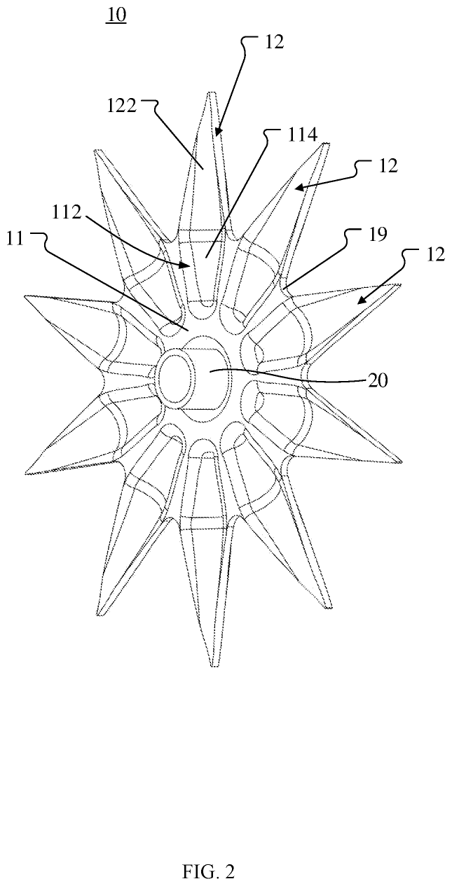

In one embodiment according to the present disclosure, as shown in FIG. 2, a perforator 10 for a lawn aerator includes a main portion 11 and a plurality of perforating portions 12. The plurality of perforating portions 12 are arranged along a circumferential direction of the main portion 11, and the plurality of perforating portions 12 may be arranged adjacently or at intervals.

The main portion 11 has a central hole 111, and an edge of the central hole 111 is provided with a flange 13. A sleeve 20 passes through the central hole 111, and an inner surface of the flange 13 is in contact with an outer surface of the sleeve 20. The sleeve 20 is connected to the perforator 10 via the flange 13, and the connection between the sleeve 20 and the perforator 10 may be achieved through welding or interference fit. The flange 13 can help to increase the contact area with the sleeve 20 passing through it, and make the connection between the sleeve 20 and the perforator 10 more stable.

The plurality of perforating portions 12 are integrally formed with the main portion 11, and extend radially outward from an outer periphery of the main portion 11. That is, the plurality of perforating portions 12 with radial configuration are arranged in the circumferential direction of the main portion 11. The perforating portions 12 forms, on one side thereof, a first concave surface 122 recessed in an axial direction of the perforator 10, and forms a first convex surface 124 on the opposite side in the axial direction. The convex height of the first convex surface 124 is substantially equal to the concave depth of the first concave surface 122.

According to the perforating portions 12 provided by the present disclosure, each perforating portion 12 is recessed in the axial direction of the perforator 10, as well as the first concave surface 122 and the first convex surface 124 are formed on two opposite side surfaces of the perforating portion 12 in the axial direction, which enlarge the outline of a single aeration hole in the soil without reducing the number of the perforating portions 12 arranged in the circumferential direction. Therefore, both a relatively high density of the aeration holes and a relatively high aeration hole size are obtained. In addition, in order to improve the strength of the perforating portion 12 in the axial direction of the perforator 10, in the present disclosure, the first concave surface 122 and the first convex surface 124 are formed on the two opposite side surfaces of the perforating portion 12 in the axial direction, which will help to strengthen the perforating portion 12, thereby preventing the perforating portion 12 from deforming under the force in the axial direction during the perforator 10 rotating.

In this embodiment, for example, by stamping the perforating portions 12, the first convex surface 124 may be formed due to the formation of the first concave surface 122. In other embodiments, the first concave surface 122 and the first convex surface 124 may also be formed separately. Specifically, the first concave surface 122 and the first convex surface 124 penetrate through the perforating portion 12 in the radial direction to obtain greater bending strength.

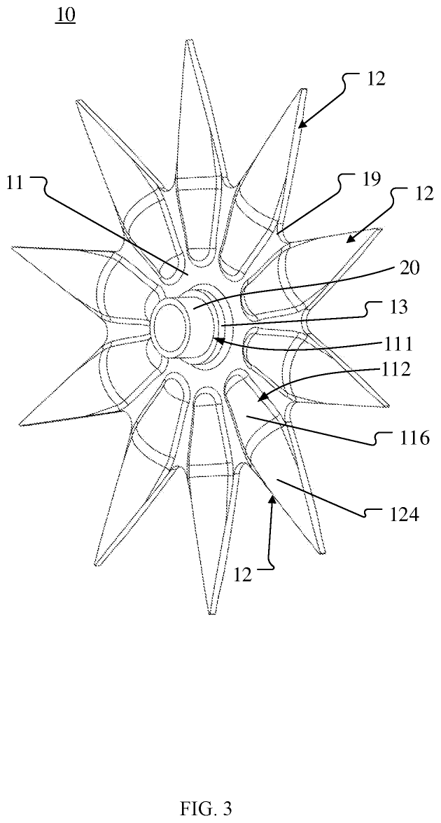

In one embodiment, as shown in FIG. 3, the main portion 11 is provided with a plurality of reinforcement portions 112, which are respectively connected to the plurality of perforating portions 12. Each reinforcement portion 112 extends radially from a corresponding perforating portion 12, and the reinforcement portion 112 can extend radially towards two opposite sides in the radial direction. One end of the reinforcement portion 112 may extend to a center of the main portion 11; the other end of the reinforcement portion 112 may extend into the perforating portion 12, and may engage with the first concave surface 122 and the first convex surface 124 of the perforating portion 12. Each reinforcement portion 112 is recessed in the axial direction, so that two opposite side surfaces of the reinforcement portion 112 in the axial direction are respectively a second concave surface 114 and a second convex surface 116. The first concave surface 122 and the second concave surface 114 are on the same side in the axial direction, and the first convex surface 124 and the second convex surface 116 are on the same side in the axial direction. That is, the second concave surface 114 is an extension of the first concave surface 122 in the radial direction, and the second convex surface 116 is an extension of the first convex surface 124 in the radial direction.

In this embodiment, the second concave surface 114 and the second convex surface 116 respectively formed on the two opposite side surfaces of the reinforcement portion 112 in the axial direction can improve the bending strength of the main portion 11.

In this embodiment, the second concave surface 114 and the second convex surface 116, respectively formed on the two opposite side surfaces of the reinforcement portion 112 in the axial direction, extend to the first concave surface 122 and the first convex surface 124 through the intersection between the main portion 11 and the perforating portion 12, so that the shear stress generated at the intersection can be better absorbed to obtain a greater bending strength. This can help to avoid “tearing” caused by excessive shear stress at the intersection between the main portion and the perforating portion, in the present disclosure.

In this embodiment, for example, by stamping the reinforcement portion 112, the second convex surface 116 may be formed due to the formation of the second concave surface 114. In other embodiments, the second concave surface 114 and the second convex surface 116 may also be formed separately. The second concave surface 114 may also be formed by stamping together with the first concave surface 122.

In this embodiment, the first concave surface 122 and the second concave surface 114 have gentle internal structures, so as to reduce concentrated stress.

In an embodiment, as shown in FIGS. 2 and 3, an arc transition portion 19 is arranged between any two adjacent perforating portions 12. The arc transition portion 19 makes a smooth transition between the two adjacent perforating portions 12. Along the circumferential direction, the arc transition portion 19 can avoid stress concentration and further improve the connection strength between the main portion 11 and the perforating portion 12.

On the side, of the perforator 10, on which the first convex surface 124 and the second convex surface 116 locate, the friction, which affects the advancing of the side along the moving direction and comes from the ground, is reduced. Meanwhile, the friction is also reduced when the perforator 10 goes in and out of the soil, thus improving the speed of perforating the soil. Therefore, perforating the soil is more labor-saving.

In an embodiment, as shown in FIGS. 2 and 3, each perforating portion 12 gradually narrows towards a side away from the main portion 11 in the radial direction of the main portion 11. In an embodiment, the perforating portion 12 is pointed at the end away from the main portion 11. This helps to increase the pressure, facilitate inserting into the soil and breaking the soil caking.

In addition, an embodiment of the present disclosure provides a lawn aerator, which may include the perforator 10 provided by the above embodiments of the present disclosure.

It should be understood that the term “including” and its variations used in the present disclosure are open-ended including, that is, “including but not limited to”. The term “one embodiment” means “at least one embodiment” and the term “another embodiment” means “at least one further embodiment”.

It should be noted that the specific technical features (elements) described in the above specific embodiments can be combined in any suitable way without contradiction, and in order to avoid unnecessary repetition, various possible combination ways are not explained in the present disclosure.

In several embodiments provided in this disclosure, it should be understood that the disclosed systems and devices can be realized in other ways.

The above are only the specific embodiments of this disclosure, but the protection scope of this disclosure is not limited to them. Any person familiar with this technical field can think of changes or substitutions within the technical scope disclosed in this disclosure, which should be included in the protection scope of this disclosure. Therefore, the scope of protection of this disclosure should be based on the scope of protection of the claims.

What is claimed is:

1. A perforator for a lawn aerator, comprising:
a main portion, in a disk shape; and
a plurality of perforating portions, integrally formed with the main portion, extending radially outward from an outer periphery of the main portion, and arranged at intervals in a circumferential direction of the main portion,
wherein each perforating portion is recessed in an axial direction of the perforator, so that two opposite surfaces of the perforating portion in the axial direction are respectively a first concave surface and a first convex surface.

2. The perforator according to claim 1, wherein the main portion is provided with a plurality of reinforcement portions respectively connected to the plurality of perforating portions; each reinforcement portion extends radially from a corresponding perforating portion, and the reinforcement portion is recessed in the axial direction, so that two opposite side surfaces of the reinforcement portion in the axial direction are respectively a second concave surface and a second convex surface; the first concave surface and the second concave surface are on the same side of the perforator in the axial direction, and the first convex surface and the second convex surface are on the same side of the perforator in the axial direction.

3. The perforator according to claim 1, wherein an arc transition portion is arranged between any two adjacent perforating portions.

4. The perforator according to claim 1, wherein each perforating portion gradually narrows towards a side away from the main portion in a radial direction of the main portion.

5. The perforator according to claim 1, wherein the main portion defines a central hole, and the perforator is provided with a flange at the edge of the central hole.

6. A lawn aerator comprising the perforator according to claim 1.
